(19) United States
(12) Patent Application Publication
(10) Pub. No.: US 2025/0077729 A1
(43) Pub. Date: Mar. 6, 2025

(54) Electrical-thermal-hydrogen Multi-Energy Device Planning Method for Zero Energy Buildings

(71) Applicants: SOUTHEAST UNIVERSITY, Nanjing (CN); Yunman Power Grid Co., Inc., Kunming (CN)

(72) Inventors: Zhi WU, Nanjing (CN); Qirun Sun, Nanjing (CN); Wei GU, Nanjing (CN); Yuping LU, Nanjing (CN); Pengxiang LIU, Nanjing (CN); Hai LU, Nanjing (CN); Enbo LUO, Nanjing (CN)

(73) Assignees: SOUTHEAST UNIVERSITY, Nanjing, CN (CN); Yunnan Power Grid Co., Ltd., Kunming, CN (CN)

(21) Appl. No.: 18/034,035

(22) PCT Filed: Mar. 29, 2022
(86) PCT No.: PCT/CN2022/083719

§ 371 Date: Apr. 26, 2023

(30) Foreign Application Priority Data
Mar. 22, 2022 (CN) 202210288704.8

(51) Int. Cl. G06F 30/20; G06F 113/06; G06Q 50/06; G06Q 50/08; H02J 3/00

(52) U.S. Cl. CPC G06F 30/20; H02J 3/00; G06F 2113/06; G06Q 50/06; G06Q 50/08; H02J 2203/20

(57) ABSTRACT

The present invention describes an electric-thermal-hydrogen multi-energy device planning method for zero energy buildings, including the following specific steps: firstly, constructing operation constraints of electric and thermal devices in the zero energy buildings; secondly, constructing operation constraints of hydrogen devices including the electrolyzer, the fuel cell and the hydrogen storage device; then, in view of constraints on annual zero energy of the buildings, establishing the robust electric-thermal-hydrogen multi-energy device planning model considering source-load uncertainties; and finally, solving the robust electric-thermal-hydrogen multi-energy device planning model of the zero energy buildings by adopting an alternating optimization procedure based column-and-constraint generation algorithm. By using the zero energy buildings, the planning method disclosed by the present disclosure plays important roles in aspects of promoting the development and utilization of renewable energy on the demand side, reducing energy consumption in the field of buildings, and reducing the emission of greenhouse gases.

### TECHNICAL FIELD

The present disclosure relates to the technical field of optimization of integrated energy systems, in particular to an electric-thermal-hydrogen multi-energy device planning method for zero energy buildings.

### BACKGROUND ART

Zero energy buildings play important roles in aspects of promoting the development and utilization of renewable energy on the demand side, reducing energy consumption in the field of buildings, reducing the emission of greenhouse gases, etc. With the rapid development of the electric hydrogen production technology, micro fuel cells and hydrogen storage technology, hydrogen devices have been widely applied to the field of energy.

In view of the collaborative application of hydrogen energy devices, electric energy devices and thermal energy devices, the seasonal and intra-day complementation of the renewable energy from photovoltaic, wind turbines, etc. can be achieved, and the renewable energy utilization efficiency can be further increased. Therefore, it has a wide application prospect in the field of buildings. In existing studies, how to utilize hydrogen energy devices to improve the operation efficiency and flexibility of the energy supply system of zero energy buildings is not taken into account.

### SUMMARY OF THE INVENTION

An objective of the present disclosure is to provide an electric-thermal-hydrogen multi-energy device planning method for zero energy buildings. The planning method plays important roles in aspects of promoting the development and utilization of renewable energy on the demand side, reducing energy consumption in the field of buildings, and reducing the emission of greenhouse gases. In view of the collaborative application of hydrogen energy devices, electric energy devices and thermal energy devices in combination with full consideration on source-load uncertainties in the zero energy buildings, the seasonal and intra-day complementation of the renewable energy from photovoltaic, wind turbines, etc. are achieved, and then, the renewable energy utilization efficiency, operation economy and flexibility of the zero energy buildings are improved. Compared with existing achievements, this planning method can effectively increase the operation efficiencies and benefits of the zero energy buildings.

The objective of the present disclosure is achieved by the following technical solutions.

Provided is an electric-thermal-hydrogen multi-energy device planning method for zero energy buildings. The planning method specifically includes the following steps:
step 1, constructing operation constraints of electric and thermal devices in the zero energy buildings;
step 2, constructing operation constraints of hydrogen devices including the electrolyzer, the fuel cell and the hydrogen storage device;
step 3, establishing the robust electric-thermal-hydrogen multi-energy device planning model considering the source-load uncertainties and the buildings' annual net zero energy constraints; and
step 4, solving the robust electric-thermal-hydrogen multi-energy device planning model by adopting an alternating optimization procedure based column-and-constraint generation algorithm.

Further, step 1 specifically includes the following steps:
step 1.1, constructing operation constraints of hydrogen devices including the electrolyzer, the fuel cell and the hydrogen storage device; and establishing operation constraints of the absorption chiller, the heat pump and the photothermal plate as follows:

$$0 \leq {Q}_{st}^{ac , in} \leq {x}_{c}^{ac} {Cap}_{c}^{ac} , 0 \leq {P}_{st}^{hp} \leq {x}_{c}^{hp} {Cap}_{c}^{hp} ; ∀ s , t$$

$${Q}_{st}^{ac , out} = {Q}_{st}^{ac , in} {η}^{ac} ; ∀ s , t$$

$$\{ \begin{matrix}{Q}_{st}^{hp , h} = {κ}^{hp} {P}_{st}^{hp} {η}_{h}^{hp} \\ {Q}_{st}^{hp , c} = ( 1 - {κ}^{hp} ) {P}_{st}^{hp} {η}_{c}^{hp}\end{matrix} ; ∀ s , t$$

$${\tilde{Q}}_{st}^{st} = {η}^{st} {x}_{c}^{st} {Cap}_{c}^{st} {\tilde{S}}_{st}^{rad} ; ∀ s , t$$

where subscripts s, t and c represent the typical operation scenario, intra-day time period and candidate device capacity, respectively, superscript ˜ represents the uncertain variables, Q_{ac,inst} [symbol] Q_{ac,out,st} represent the input thermal power and output cold power of the absorption chiller, respectively, Pₕₚₛₜ [symbol] Q_{hp,hst} [symbol] Q_{hp,cst} represent the input electric power, output thermal power and output cold power of the heat pump, respectively, \tilde{Q}ₛₜ^{st} represents the output thermal power of the photothermal plate, η^{ac} [symbol] η^{st} represent the conversion efficiency of the absorption chiller and the photothermal plate, respectively, η_{hp h} [symbol] η_{hp c} represent the electric-to-thermal conversion and electric-to-cold conversion efficiency of the heat pump, respectively, κ^{hp} represents the thermal power distribution ratio of the heat pump, x_{acc} [symbol] x_{hpc} [symbol] x_{stc} represent the 0-1 installation variables of the absorption chiller, the heat pump and the photothermal plate, respectively, Cap_{acc} [symbol] Cap_{hpc} [symbol] Cap_{stc} represent the candidate installation capacity of the absorption chiller, the heat pump and the photothermal plate, respectively, and \tilde{S}ₛₜ^{rad} represents the solar radiation intensity; and
step 1.2, establishing operation constraints of the photovoltaic and wind turbine as follows:

$${\tilde{P}}_{st}^{pv} = {η}^{pv} {x}_{c}^{pv} {Cap}_{c}^{pv} {\tilde{S}}_{st}^{rad} ; ∀ s , t$$

$${\tilde{P}}_{st}^{wt} = {\tilde{ξ}}_{st}^{wt} {x}_{c}^{wt} {Cap}_{c}^{wt} ; ∀ s , t$$

where \tilde{P}ₛₜ^{pv} [symbol] \tilde{P}ₛₜ^{wt} represent the output electric power of the photovoltaic and wind turbine, respectively, x_{pvc} [symbol] x_{wtc} represent the 0-1 installation variables of the photovoltaic and wind turbine, respectively, Cap_{pvc} [symbol] Cap_{wtc} represent the candidate installation capacity of the photovoltaic and wind turbine, respectively, η^{pv} represents the conversion efficiency of the photovoltaic, and \tilde{ξ}ₛₜ^{wt} represents the output ratio of the wind turbine.

Further, step 2 specifically includes the following steps:
step 2.1, establishing operation constraints of the fuel cell and the electrolyzer as follows:

$${I}_{st}^{\{ \cdot \} , on} + {I}_{st}^{\{ \cdot \} , off} \leq 1 , \{ \cdot \} = \{ chp , ed \} ; ∀ s , t$$

$${\sum }_{t = k}^{k + {N}_{min}^{\{ \cdot \} , on} - 1} {I}_{st}^{\{ \cdot \} , on} \leq 1 , {\sum }_{t = k}^{k + {N}_{min}^{\{ \cdot \} , on} - 1} ( {I}_{st}^{\{ \cdot \} , on} + {I}_{st}^{\{ \cdot \} , off} ) \leq 1 , \{ \cdot \} = \{ chp , ed \} ; ∀ s , k ∈ [ 1 , {N}_{t} - {N}_{min}^{\{ \cdot \} , on} + 1 ]$$

$${\sum }_{t = k}^{k + {N}_{min}^{\{ \cdot \} , off} - 1} {I}_{st}^{\{ \cdot \} , off} \leq 1 , {\sum }_{t = k}^{k + {N}_{min}^{\{ \cdot \} , off} - 1} ( {I}_{st}^{\{ \cdot \} , on} + {I}_{st}^{\{ \cdot \} , off} ) \leq 1 , \{ \cdot \} = \{ chp , ed \} ; ∀ s , k ∈ [ 1 , {N}_{t} - {N}_{min}^{\{ \cdot \} , off} + 1 ]$$

$${\sum }_{t = k}^{k + {N}_{max}^{\{ \cdot \} , on}} {ε}_{st}^{\{ \cdot \}} \leq {N}_{max}^{\{ \cdot \} , on} , \{ \cdot \} = \{ chp , ed \} ; ∀ s , k ∈ [ 1 , {N}_{t} - {N}_{max}^{\{ \cdot \} , on} ]$$

$${I}_{st}^{\{ \cdot \} , on} - {I}_{st}^{\{ \cdot \} , off} = {ε}_{st}^{\{ \cdot \}} - {ε}_{s , t - 1}^{\{ \cdot \}} , \{ \cdot \} = \{ chp , ed \} ; ∀ s , t$$

$${δ}^{\{ \cdot \}} {ε}_{st}^{\{ \cdot \}} {x}_{c}^{\{ \cdot \}} {Cap}_{c}^{\{ \cdot \}} \leq {P}_{st}^{\{ \cdot \} , in} \leq {ε}_{st}^{\{ \cdot \}} {x}_{c}^{\{ \cdot \}} {Cap}_{c}^{\{ \cdot \}} , \{ \cdot \} = \{ chp , ed \} ; ∀ s , t$$

$$\{ \begin{matrix}{P}_{st}^{\{ \cdot \} , in} - {P}_{s , t - 1}^{\{ \cdot \} , in} \leq {Ra}_{st}^{\{ \cdot \}} \leq {Ra}_{max}^{\{ \cdot \}} \\ {P}_{s , t - 1}^{\{ \cdot \} , in} - {P}_{st}^{\{ \cdot \} , in} \leq {Ra}_{st}^{\{ \cdot \}} \leq {Ra}_{max}^{\{ \cdot \}}\end{matrix} , \{ \cdot \} = \{ chp , ed \} ; ∀ s , t$$

$${P}_{st}^{\{ \cdot \} , out} = {η}^{\{ \cdot \}} {P}_{st}^{\{ \cdot \} , in} , \{ \cdot \} = \{ chp , ed \} ; ∀ s , t$$

$${Q}_{st}^{chp , out} = {κ}^{chp} ( {P}_{st}^{chp , in} - {P}_{st}^{chp , out} ) ; ∀ s , t$$

where k represents the intra-day time periods, Nₜ represents the number of the intra-day time periods, chp and ed represent the fuel cell and the electrolyzer, respectively, {⋅} represents the set of two devices, I_{{⋅},onst} [symbol] I_{{⋅},offst} represent the on-state and off-state of these two devices, respectively, N_{{⋅},onmin} [symbol] N_{{⋅},offmin} represent the minimum on-state and off-state time of these two devices, respectively, N_{{⋅},onmax} represents the maximum on-state time of these two devices, ε_{{⋅}st} [symbol] ε_{{⋅}s,t}_{_{1̅}} represent the state of these two devices within time periods t and t−1, respectively, δ^{{⋅}} represents the minimum operation capacity percentage of these two devices, x_{{⋅}c} represents the 0-1 installation variables of these two devices, Cap_{{⋅}c} represents the candidate installation capacity of these two devices, P_{chp,inst} [symbol] P_{chp,outst} [symbol] Q_{chp,outst} represent the input hydrogen power, output electric power and output thermal power of the fuel cell, respectively, P_{ed,inst} [symbol] P_{ed,outst} represent the input electric power and output hydrogen power of the electrolyzer, respectively, Ra_{{⋅}st} represents the ramping ratio of these two devices, Ra_{{⋅}max} represents the maximum ramping ratio of these two devices, η^{{⋅}} represents the energy conversion efficiencies of these two devices, and κ^{chp} represents the heat recovery ratio of the fuel cell; and
step 2.2, establishing operation constraints of the intra-day hydrogen storage device and the seasonal hydrogen storage device as follows:

$$0 \leq {P}_{st}^{\{ \cdot \} , + / -} \leq {x}_{i}^{\{ \cdot \}} {Cap}_{i}^{\{ \cdot \}} {μ}^{\{ \cdot \}} , \{ \cdot \} = \{ bs , hs , shs \} ; ∀ s , t$$

$$0 \leq {Q}_{st}^{ts , + / -} \leq {x}_{c}^{ts} {Cap}_{c}^{ts} {μ}^{ts} ; ∀ s , t$$

$${P}_{st}^{\{ \cdot \} +} \cdot {P}_{st}^{\{ \cdot \} -} = 0 , \{ \cdot \} = \{ bs , hs , shs \} ; ∀ s , t$$

$${Q}_{st}^{ts , +} \cdot {Q}_{st}^{ts -} = 0 ; ∀ s , t$$

$${x}_{c}^{\{ \cdot \}} {Cap}_{c}^{\{ \cdot \}} {δ}_{min}^{\{ \cdot \}} \leq {E}_{st}^{\{ \cdot \}} \leq {x}_{c}^{\{ \cdot \}} {Cap}_{c}^{\{ \cdot \}} {δ}_{max}^{\{ \cdot \}} , \{ \cdot \} = \{ bs , hs , shs , ts \} ; ∀ s , t$$

$${E}_{s , {N}_{t}}^{\{ \cdot \}} = {E}_{s , 0}^{\{ \cdot \}} = ( {x}_{c}^{\{ \cdot \}} {Cap}_{c}^{\{ \cdot \}} ) / 2 , \{ bs , hs , shs , ts \} ; ∀ s , t$$

$${E}_{s , t + 1}^{\{ \cdot \}} = {E}_{st}^{\{ \cdot \}} ( 1 - {η}^{\{ \cdot \}} ) + ( {P}_{st}^{\{ \cdot \} +} {η}^{\{ \cdot \} +} - {P}_{st}^{\{ \cdot \} -} / {η}^{\{ \cdot \} -} ) Δ t , \{ \cdot \} = \{ bs , hs , shs , ts \} ; ∀ s , t$$

$${E}_{s , 0}^{shs} = ( 1 - {η}^{shs} {D}_{s - 1} ) ( {E}_{s - 1 , 0}^{shs} + {D}_{s - 1} ( {E}_{s - 1 , {N}_{t}}^{shs} - {E}_{s - 1 , 0}^{shs} ) ) ; ∀ s ∈ [ 2 , {N}_{s} ]$$

$${ε}_{s}^{shs +} + {ε}_{s}^{shs -} \leq 1 ; ∀ s$$

$$0 \leq {P}_{st}^{shs +} \leq {ε}_{s}^{shs +} M , 0 \leq {P}_{st}^{shs -} \leq {ε}_{s}^{shs -} M ; ∀ s , t$$

where bs, hs, shs and ts represent the battery storage, the intra-day hydrogen storage device, the seasonal hydrogen storage device and the thermal energy storage device, respectively, {⋅} represents the set of these four devices, Nₛ represents the number of typical scenarios, P_{bs+st} [symbol] P_{bs-st} represent the charging power and discharging power of the battery storage, respectively, Pₕₛ₊ₛₜ [symbol] Pₕₛ₋ₛₜ represent the hydrogen charging power and hydrogen discharging power of the intra-day hydrogen storage device, respectively, Pₛₕₛ₊ₛₜ [symbol] Pₛₕₛ₋ₛₜ represent the hydrogen charging power and hydrogen discharging power of the seasonal hydrogen storage device, respectively, Qₜₛ₊ₛₜ [symbol] Qₜₛ₋ₛₜ represent the heat charging power and heat discharging power of the thermal energy storage device, respectively, x_{{⋅}c} represents 0-1 installation variables of these four energy storage devices, Cap_{{⋅}c} represents the candidate installation capacity of these four energy storage devices, μ^{{⋅}} represents the power-to-capacity installation ratio of these four energy storage devices, and E_{{⋅}st} represents the remaining capacity of these four energy storage devices; δ_{{⋅}min} [symbol] δ_{{⋅}max} respectively represent the minimum and maximum operating ratio of these four energy storage devices, respectively, E_{{⋅}s,0} [symbol] E_{{⋅}s,N}_{ₜ} represent the capacity of these four energy storage devices in the initial and final time periods, respectively, η^{{⋅}} represents the self-loss coefficients of these four energy storage devices, η^{{⋅}+} [symbol] η^{{⋅}-} represent the energy charging and discharging loss coefficients of these four energy storage devices, respectively, and Dₛ₋₁ represents the number of days within the typical scenario s−1 in a year, Eₛₕₛₛ_{_{1̅}}_{,0} [symbol] Eₛₕₛₛ_{_{1̅}}_{,N}_{ₜ} represent the remaining capacity of the seasonal hydrogen storage device in the initial and final time periods in the scenario s−1, respectively, εₛₕₛ₊ₛ [symbol] εₛₕₛ₋ₛ represent the 0-1 state variables of hydrogen charge and hydrogen discharge of the seasonal hydrogen storage device in the typical operation scenario s, respectively, and M represents a larger positive number.

Further, step 3 specifically includes the following steps:
step 3.1, establishing the balance constraints of electric, thermal, cold and hydrogen power as follows:

$${P}_{st}^{bs -} - {P}_{st}^{bs +} + {P}_{st}^{chp , out} + {P}_{st}^{grid +} - {P}_{st}^{grid -} - {P}_{st}^{hp} + {\tilde{P}}_{st}^{pv} - {P}_{st}^{ed , in} + {\tilde{P}}_{st}^{wt} = {\tilde{P}}_{st}^{el} - {P}_{st}^{se} ; ∀ s , t$$

$${Q}_{st}^{hp , h} + {Q}_{st}^{chp , out} + {Q}_{st}^{st} - {Q}_{st}^{ts +} + {Q}_{st}^{ts -} - {Q}_{st}^{ac , in} = {\tilde{Q}}_{st}^{hl} - {Q}_{st}^{sh} ; ∀ s , t$$

$${Q}_{st}^{ac , out} + {Q}_{st}^{hp , c} = {\tilde{Q}}_{st}^{cl} - {Q}_{st}^{sc} ; ∀ s , t$$

$${P}_{st}^{ed , out} + {P}_{st}^{sps -} - {P}_{st}^{shs +} + {P}_{st}^{hs -} - {P}_{st}^{hs +} = {P}_{st}^{chp , i n} ; ∀ s , t$$

where P_{gird+st} [symbol] P_{gird-st} respectively represent the zero energy buildings' electric power buying from and selling to the power grid, respectively, \tilde{P}ₛₜ^{el} [symbol] \tilde{P}ₛₜ^{hl} [symbol] \tilde{P}ₛₜ^{cl} respectively represent the electric, thermal and cold loads of the buildings, respectively, Pₛₑₛₜ [symbol] Pₛₕₛₜ [symbol] P_{scst} respectively represent the shedding power of the electric, thermal and cold loads of the zero energy buildings, respectively;
step 3.2, establishing output power upper limit constraints of the electric, thermal and cold loads as follows:

$$0 \leq {P}_{st}^{se} \leq {δ}_{max}^{se} {\hat{P}}_{st}^{el} ; ∀ s , t$$

$$0 \leq {Q}_{st}^{sh} \leq {δ}_{max}^{sh} {\hat{Q}}_{st}^{hl} ; ∀ s , t$$

$$0 \leq {Q}_{st}^{sh} \leq {δ}_{max}^{sh} {\hat{Q}}_{st}^{cl} ; ∀ s , t$$

where \hat{P}ₛₜ^{el} [symbol] \hat{P}ₛₜ^{hl} [symbol] \hat{P}ₛₜ^{cl} represent the forecast values of the electric, thermal and cold loads of the zero energy buildings, and δₛₑₘₐₓ [symbol] δₛₕₘₐₓ [symbol] δ_{scmax} represent the maximum output percentages of the electric, thermal and cold loads of the buildings, respectively;
step 3.3, establishing power grid exchange power constraints and annual zero energy constraints as follows:

$$0 \leq {P}_{st}^{grid +} \leq {ε}_{st}^{grid +} {P}_{max}^{grid} , 0 \leq {P}_{st}^{grid -} \leq {ε}_{st}^{grid -} {P}_{max}^{grid} ; ∀ s , t$$

$${ε}_{st}^{grid +} + {ε}_{st}^{grid -} \leq 1 ; ∀ s , t$$

$${\sum }_{s} {\sum }_{t} {P}_{st}^{grid +} Δ t - {\sum }_{s} {\sum }_{t} {P}_{st}^{grid -} Δ t \leq 0$$

where P_{girdmax} represents the upper limit of the exchange electric power with power grid, ε_{grid+st} [symbol] ε_{grid-s} respectively represent the 0-1 state variables of the electric power buying from and selling to the power grid, respectively, and Δt represents the duration of time period t;
step 3.4, establishing the objective function and various specific costs as follows:

$${min}_{x} {C}^{inv} + {max}_{u} {min}_{y , z} {C}^{om} + {C}^{grid} + {C}^{deg} + {C}^{ls}$$

$${C}_{ψ}^{inv} = {c}_{ψ}^{inv} {x}_{c}^{ψ} {Cap}_{c}^{ψ} {ϕ}_{ψ}$$

$${C}^{inv} = {C}_{ac}^{inv} + {C}_{bs}^{inv} + {C}_{chp}^{inv} + {C}_{ed}^{inv} + {C}_{hp}^{inv} + {C}_{hs}^{inv} + {C}_{pv}^{inv} + {C}_{shs}^{inv} + {C}_{st}^{inv} + {C}_{ts}^{inv} + {C}_{wt}^{inv}$$

$${ϕ}_{ψ} = {σ ( 1 + σ )}^{{Y}_{ψ}} / ( {( 1 + σ )}^{{Y}_{ψ}} - 1 )$$

$${C}^{om} = {\sum }_{s} {D}_{s} {\sum }_{t} ( \begin{matrix}\begin{matrix}{c}_{chp}^{on} {I}_{st}^{chp} + {c}_{chp}^{off} {I}_{st}^{chp} + {c}_{ed}^{on} {I}_{st}^{ed} + {c}_{ed}^{off} {I}_{st}^{ed} + {c}_{bs}^{om} ( {P}_{wst}^{bs +} + {P}_{wst}^{bs -} ) + \\ {c}_{chp}^{om} {P}_{wst}^{chp , in} + {c}_{ed}^{om} {P}_{wst}^{ed} +\end{matrix} \\ \begin{matrix}{c}_{hp}^{om} + {P}_{st}^{hp} + {c}_{pv}^{om} {P}_{st}^{pv} + {c}_{wt}^{om} {P}_{st}^{wt} + {c}_{hs}^{om} ( {P}_{st}^{hs +} + {P}_{st}^{hs -} ) + \\ {c}_{shs}^{om} ( {P}_{st}^{shs +} + {P}_{st}^{shs -} ) +\end{matrix} \\ {c}_{ac}^{om} {Q}_{st}^{ac} + {c}_{st}^{om} {Q}_{st}^{st} + {c}_{ts}^{om} ( {Q}_{st}^{ts +} + {Q}_{st}^{ts -} )\end{matrix} ) Δ t$$

$${C}^{deg} = {\sum }_{s} {D}_{s} {\sum }_{t} ( {c}_{bs}^{deg} ( {P}_{st}^{bs +} + {P}_{st}^{bs -} ) + {c}_{chp}^{deg} {Ra}_{st}^{chp} + {c}_{ed}^{deg} {Ra}_{st}^{ed} ) Δ t$$

$${C}^{grid} = {\sum }_{s} {D}_{s} {\sum }_{t} ( {c}_{st}^{buy} {P}_{st}^{grid +} - {c}_{st}^{sell} {P}_{st}^{grid -} ) Δ t$$

$${C}^{ls} = {\sum }_{s} {D}_{s} {\sum }_{t} ( {c}_{e}^{ls} {P}_{st}^{se} + {c}_{h}^{ls} {Q}_{st}^{sh} + {c}_{c}^{ls} {Q}_{st}^{sc} ) Δ t$$

where Ψ represents the set of devices, Dₛ represents the number of days that the typical scenario s lasts, and C^{inv} [symbol] C^{om} [symbol] C^{grid} [symbol] C^{deg} [symbol] C^{ls} represent the annual investment cost, annual operation and maintenance cost, annual electricity trading cost, annual device degradation cost and annual load shedding cost, respectively, C_{inv ac} [symbol] C_{inv bs} [symbol] C_{inv chp} [symbol] C_{inv ed} [symbol] C_{inv hp} [symbol] C_{inv hs} [symbol] C_{inv pv} [symbol] C_{inv shs} [symbol] C_{inv st} [symbol] C_{inv ts} [symbol] C_{inv wt} represent the annual investment costs of the absorption chiller, the battery storage, the fuel cell, the electrolyzer, the heat pump, the intra-day hydrogen storage device, the photovoltaic, the seasonal hydrogen storage device, the photothermal plate, the thermal energy storage and the wind turbine, respectively;
x represents the 0-1 variables of the robust model at the first stage, u represents uncertain variables at the second stage, y and z represent continuous and 0-1 operation variables in the worst scenario at the second stage, respectively, Φ_{Ψ} represents the present worth factor, σ represents the discount rate, Y_{Ψ} represents the lifetime of the energy device, and c_{inv Ψ} represents the device unit investment cost;
x_{Ψc} represents the 0-1 device investment variables, Cap_{Ψc} represents the candidate installation capacity of energy device, c_{chp}^{on} [symbol] c_{off chp} respectively represent the startup and shutdown cost of the fuel cell, respectively, c_{ed}^{on} [symbol] c_{off ed} represent the startup and shutdown cost of the electrolyzer, respectively, and c_{bs}^{om} [symbol] c_{chp}^{om} [symbol] c_{ed}^{om} [symbol] cₕₚ^{om} [symbol] cₚᵥ^{om} [symbol] c_{wt}^{om} [symbol] c_{om hs} [symbol] cₛₕₛ^{om} [symbol] c_{ac}^{om} [symbol] cₛₜ^{om} [symbol] cₜₛ^{om} cₛₜ^{om} [symbol] cₜₛ^{om} represent the unit operation costs of the battery storage, the fuel cell, the electrolyzer, the heat pump, the photovoltaic, the wind turbine, the hydrogen storage, the seasonal hydrogen storage device, the absorption chiller, the photothermal plate and the thermal energy storage device, respectively, c_{bs}^{deg} [symbol] c_{chp}^{deg} [symbol] c_{ed}^{deg} respectively represent the unit degradation costs of the battery storage, the fuel cell and the electrolyzer, respectively, c_{buy st} [symbol] c_{sell st} represent the electricity buying and selling costs, respectively, and cₑ^{ls} [symbol] cₕ^{ls} [symbol] c_{c}^{ls} represent the unit load shedding costs of the electric, thermal and cold loads, respectively; and
establishing constraints of intra-day uncertainties such as the electric, thermal and cold loads, output of the wind turbine and solar radiation as follows:

$$U = \{ {\tilde{P}}^{el} ∈ {R}^{{N}_{s} \times {N}_{t}} ; {\tilde{P}}_{st}^{el} = {\hat{P}}_{st}^{el} + {P}_{st}^{el +} {ϛ}_{st}^{el +} - {P}_{st}^{el -} {ϛ}_{st}^{el -} , {ϛ}_{st}^{el + / -} ∈ \{ 0 , 1 \} , \text{?} ( {ϛ}_{st}^{el +} + {ϛ}_{st}^{el -} ) \leq {Γ}_{s}^{el} \} ∀ s , t$$

$$\text{?} \text{indicates text missing or illegible when filed}$$

where U represents the set of the uncertain variables at the second stage, \tilde{P}^{el} represents the uncertain electric load, \tilde{P}ₛₜ^{el} [symbol] \hat{P}ₛₜ^{el} [symbol] Pₛₜ^{el+} [symbol] Pₛₜ^{el-} [symbol] represent the actual value, the predicted value, the predicted upper deviation value and the predicted lower deviation value of the electric load, respectively, [symbol] [symbol] [symbol] respectively represent 0-1 variables of the predicted upper deviation value or the predicted lower deviation value of the electric load, and Γₛ^{el} represents the uncertainty budget parameter of an entire scheduling horizon within a typical operation scenario.

Further, step 4 specifically includes the following steps:
step 4.1, rewriting the electric-thermal-hydrogen multi-energy device planning model into a general matrix form:

$${min}_{x} {A}^{T} x + {max}_{u ∈ U} {min}_{y , z ∈ Ω ( x , u )} {C}^{T} y + {D}^{T} z$$

$$s . t . {B}^{T} x \leq b , x ∈ \{ 0 , 1 \}$$

$$Ey + Fz + Gu \leq l - Hx , z ∈ \{ 0 , 1 \}$$

where A [symbol] B [symbol] C [symbol] D [symbol] E [symbol] F [symbol] G [symbol] H [symbol] b [symbol] l represent the set of uncertain variables at the second stage, and Ω(x,u) represents the feasible region of y and z under certain x and u;
step 4.2, converting the min-max-min two-stage robust planning problem into a main problem and a subproblem, converting the subproblem into a u-fixed subproblem and a z-fixed subproblem, and iteratively solving the main problem and the subproblem to obtain the optimization result; where the subproblem is a max-min bilevel optimization problem shown as follows:

$${max}_{u ∈ U} {min}_{y , z ∈ Ω ( x , u )} {C}^{T} y + {D}^{T} z$$

$$s . t . {B}^{T} {x}^{*} \leq b$$

$$Ey + Fz + Gu \leq l - {Hx}^{*} , z ∈ \{ 0 , 1 \}$$

where x* represents the optimization result in the main problem and serves as known variables to be substituted into the subproblem; and
step 4.3, iteratively solving the main problem and the subproblem.

Further, the subproblem in step 4.2 is further decomposed into:
step 4.2.1, the u-fixed subproblem:

$${min}_{y , z} {C}^{T} y + {D}^{T} z$$

$$s . t . Ey + Fz + {Gu}^{*} \leq f - {Hx}^{*} , z ∈ \{ 0 , 1 \}$$

where u* represents the optimization result in the z-fixed subproblem and serves as known variables to be substituted into the u-fixed subproblem; and
step 4.2.2, the z-fixed subproblem:

$${max}_{u , λ} θ = - {λ}^{T} ( l - {Hx}^{*} - Gu - {Fz}^{*} ) + {D}^{T} {z}^{*}$$

$$s . t . - {λ}^{T} E \geq {C}^{T} , {λ}^{T} \geq 0$$

where θ represents the objective function of the z-fixed subproblem, z* represents the optimization result in the u-fixed subproblem and serves as known variables to be substituted into the fixed z-subproblem, λ represents the dual variable of the inequality constraint, and in view of higher difficulty in solution due to a bilinear term λ^{T}u, the above formulation is converted into a linear optimization problem by using the big-M method, and the u-fixed subproblem and the z-fixed subproblem are iteratively solved until convergence to obtain the optimization result of the subproblem;
the m^{th} optimization result u^{m}* of the subproblem is substituted, and new variables yₘ, zₘ are created to obtain the following main problem:

$${min}_{x} {A}^{T} x + η$$

$$s . t . {B}^{T} x \leq b , x ∈ \{ 0 , 1 \}$$

$$η \geq {C}^{T} {y}_{m} + {D}^{T} {z}_{m} , ∀ 1 \leq m \leq r$$

$${Ey}_{m} + {Fz}_{m} + {Gu}^{{m}^{*}} \leq l - Hx , ∀ 1 \leq m \leq r$$

where r represents the total number of iterations, and the main problem and the subproblem are iteratively solved until the convergence condition is met.

Further, the step of iteratively solving the main problem and the subproblem in step 4.3 includes:
initialization: setting x⁰ as a feasible solution of the main problem, setting the number of iterations as m=1, and substituting x⁰ into the subproblem iteration processes shown in steps 4.3.2 to 4.3.5 to obtain the subproblem's solution (u^{m}*, θ^{m}*); and setting the lower boundary LB=−∞ and the upper boundary UB=+∞, and setting the main problem convergence coefficient ε;
step 4.3.1, substituting u^{m}* into the main problem to obtain) the solution (x^{m}*, η^{m}*), and updating LB=A^{T}x^{m}*+η^{m}*;
step 4.3.2, setting the number of iterations as v=1, relaxing z as the continuous variable, and substituting x^{m}* into the fixed subproblem z to obtain the solution u^{v};
step 4.3.3, substituting (x^{m}*, u^{v}) into the u-fixed subproblem to obtain the solution (y^{v}, z^{v});
step 4.3.4, substituting (z^{v}, x^{m}) into the z-fixed subproblem to obtain the solution (u^{v+1}, z^{v+1}), set v=v+1;
step 4.3.5, determining whether u^{v}==u^{v-1} is satisfied, if yes, outputting the optimization result (u^{m}*, θ^{m}*)=(u^{v}, θ^{v}), updating UB=A^{T}x^{m}*+θ^{m}*, and entering step 4.3.6; or else, returning to step 4.3.3; and
step 4.3.6, determining whether −ε<(UB−LB)/UB<ε is satisfied, if yes, stopping outputting the optimization result; or else, returning to step 4.3.1.

The present disclosure has the beneficial effects:
1. By using the zero energy buildings, the planning method disclosed by the present disclosure plays important roles in aspects of promoting the development and utilization of renewable energy on the demand side, reducing energy consumption in the field of buildings, and reducing the emission of greenhouse gases; and
2. In view of the collaborative application of hydrogen energy devices, electric energy devices and thermal energy devices in combination with full consideration on source-load uncertainties in the zero energy buildings, the seasonal and intra-day complementation of the renewable energy from photovoltaic,, wind turbines, etc. are achieved, and the renewable energy utilization efficiency, operation economy and flexibility of the zero energy buildings can be further improved. Compared with existing achievements, this planning method can effectively increase the operation efficiencies and benefits of the zero energy buildings.

### BRIEF DESCRIPTION OF THE DRAWINGS

The present disclosure will be further described below in conjunction with accompanying drawing:

FIG. 1 is a structural diagram of electric-thermal-hydrogen multi-energy devices for zero energy buildings in the present disclosure; and

FIG. 2 is the process diagram of the planning method in the present disclosure.

### DETAILED DESCRIPTION OF THE INVENTION

The technical solutions in the embodiments of the present disclosure will be described clearly and completely below in conjunction with the accompanying drawings in the embodiments of the present disclosure. Obviously, the described embodiments are only a part of the embodiments of the present disclosure, not all the embodiments. Based on the embodiments of the present disclosure, all other embodiments obtained by those of ordinary skill in the art without creative work shall fall within the protection scope of the present disclosure.

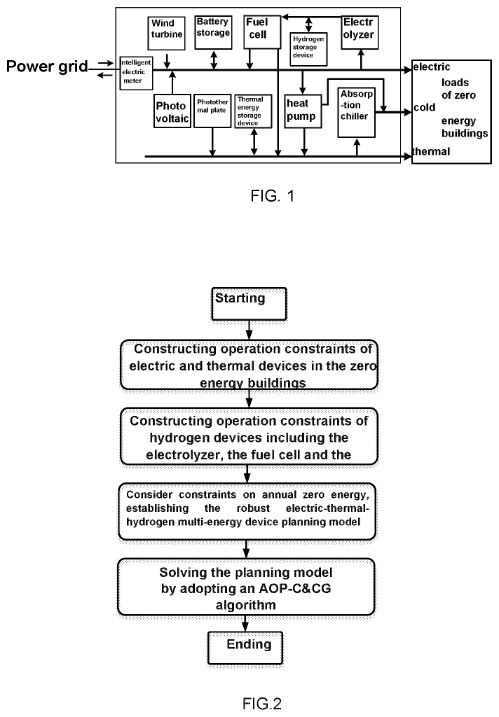

As shown in FIG. 1, the electric-thermal-hydrogen multi-energy devices for zero energy buildings include photovoltaic, a wind turbine, a battery storage, a heat pump, a photothermal plate, an absorption chiller, a thermal energy storage device, a fuel cell, an electrolyzer, an intra-day hydrogen storage device and a seasonal hydrogen storage device, where the photovoltaic and wind turbine generate electric energy, the heat pump converts electric energy into thermal energy, and the photothermal plate generates thermal energy.

The absorption chiller converts thermal energy into cold energy, the electrolyzer converts electric energy into hydrogen energy, the micro fuel cell converts hydrogen energy into electric energy and thermal energy, remaining electric, thermal and hydrogen energy is respectively stored by various energy storage devices, and the multi-energy-flow device supplies energy to electric, thermal and cold loads in the building by energy conversion and cooperation and enables the sum of electric quantity input from the power grid to the building within a year to be less than or equal to the output value thereof, that is, the requirement for yearly net zero energy target is met. As shown in FIG. 2, the electric-thermal-hydrogen multi-energy device planning method for zero energy buildings specifically includes the following steps:
step 1, operation constraints of electric and thermal devices in the zero energy buildings are constructed;
step 1.1, operation constraints of the absorption chiller, the heat pump and the photothermal plate are established as follows:

$$0 \leq {Q}_{st}^{ac , in} \leq {x}_{c}^{ac} {Cap}_{c}^{ac} , 0 \leq {P}_{st}^{hp} \leq {x}_{c}^{hp} {Cap}_{c}^{hp} ; ∀ s , t$$

$${Q}_{st}^{ac , out} = {Q}_{st}^{ac , in} {η}^{ac} ; ∀ s , t$$

$$\{ \begin{matrix}{Q}_{st}^{hp , h} = {κ}^{hp} {P}_{st}^{hp} {η}_{h}^{hp} \\ {Q}_{st}^{hp , c} = ( 1 - {κ}^{hp} ) {P}_{st}^{hp} {η}_{c}^{hp}\end{matrix} ; ∀ s , t$$

$${\tilde{Q}}_{st}^{st} = {η}^{st} {x}_{c}^{st} {Cap}_{c}^{st} {\tilde{S}}_{st}^{rad} ; ∀ s , t$$

where subscripts s, t and c represent the typical operation scenario, intra-day time period and candidate device capacity, respectively, superscript ˜ represents the uncertain variables, Qₛₜ^{ac,in} [symbol] Qₛₜ^{ac,out} represent the input thermal power and output cold power of the absorption chiller, respectively, Pₛₜ^{hp} [symbol] Qₛₜ^{hp,h} [symbol] Qₛₜ^{hp,c} represent the input electric power, output thermal power and output cold power of the heat pump, respectively, \tilde{Q}ₛₜ^{st} represents the output thermal power of the photothermal plate, and η^{ac} [symbol] η^{st} represent the conversion efficiency of the absorption chiller and the photothermal plate, respectively; ηₕ^{hp} [symbol] η_{c}^{hp} represent the electric-to-thermal conversion and electric-to-cold conversion efficiency of the heat pump, respectively, κ^{hp} represents the thermal power distribution ratio of the heat pump, x_{c}^{ac} [symbol] x_{c}^{hp} [symbol] x_{c}^{st} represent the 0-1 installation variables of the absorption chiller, the heat pump and the photothermal plate, respectively, Cap_{c}^{ac} [symbol] Cap_{c}^{hp} [symbol] Cap_{c}^{st} represent the candidate installation capacity of the absorption chiller, the heat pump and the photothermal plate, respectively, and \tilde{S}ₛₜ^{rad} represents the solar radiation intensity; and
step 1.2, operation constraints of photovoltaic and wind turbine are established as follows:

$${\tilde{P}}_{st}^{pv} = {η}^{pv} {x}_{c}^{pv} {Cap}_{c}^{pv} {\tilde{S}}_{st}^{rad} ; ∀ s , t$$

$${\tilde{P}}_{st}^{wt} = {\tilde{ξ}}_{st}^{wt} {x}_{c}^{wt} {Cap}_{c}^{wt} ; ∀ s , t$$

where \tilde{P}ₛₜ^{pv} [symbol] \tilde{P}ₛₜ^{wt} represent the output electric power of the photovoltaic and wind turbine, respectively, x_{c}^{pv} [symbol] x_{c}^{wt} represent the 0-1 installation variables of the photovoltaic and wind turbine, respectively, Cap_{c}^{pv} [symbol] Cap_{c}^{wt} represent the candidate installation capacity of the photovoltaic and wind turbine, respectively, η^{pv} represents the conversion efficiency of the photovoltaic, and \tilde{ξ}ₛₜ^{wt} represents the output ratio of the wind turbine.

Step 2, operation constraints of hydrogen devices including the electrolyzer, the fuel cell and the hydrogen storage device are constructed;
step 2.1, operation constraints of the fuel cell and the electrolyzer are established as follows:

$${I}_{st}^{\{ \cdot \} , on} + {I}_{st}^{\{ \cdot \} , off} \leq 1 , \{ \cdot \} = \{ chp , ed \} ; ∀ s , t$$

$${\sum }_{t = k}^{k + {N}_{min}^{\{ \cdot \} , on} - 1} {I}_{st}^{\{ \cdot \} , on} \leq 1 , {\sum }_{t = k}^{k + {N}_{min}^{\{ \cdot \} , on} - 1} ( {I}_{st}^{\{ \cdot \} , on} + {I}_{st}^{\{ \cdot \} , off} ) \leq 1 , \\ \{ \cdot \} = \{ chp , ed \} ; ∀ s , k ∈ [ 1 , {N}_{t} - {N}_{min}^{\{ \cdot \} , on} + 1 ]$$

$${\sum }_{t = k}^{k + {N}_{min}^{\{ \cdot \} , off} - 1} {I}_{st}^{\{ \cdot \} , off} \leq 1 , {\sum }_{t = k}^{k + {N}_{min}^{\{ \cdot \} , off} - 1} ( {I}_{st}^{\{ \cdot \} , on} + {I}_{st}^{\{ \cdot \} , off} ) \leq 1 , \\ \{ \cdot \} = \{ chp , ed \} ; ∀ s , k ∈ [ 1 , {N}_{t} - {N}_{min}^{\{ \cdot \} , off} + 1 ]$$

$${\sum }_{t = k}^{k + {N}_{max}^{\{ \cdot \} , on}} {ε}_{st}^{\{ \cdot \}} \leq {N}_{max}^{\{ \cdot \} , on} , \{ \cdot \} = \{ chp , ed \} ; ∀ s , k ∈ [ 1 , {N}_{t} - {N}_{max}^{\{ \cdot \} , on} ]$$

$${I}_{st}^{\{ \cdot \} , on} - {I}_{st}^{\{ \cdot \} , off} = {ε}_{st}^{\{ \cdot \}} - {ε}_{s , t - 1}^{\{ \cdot \}} , \{ \cdot \} = \{ chp , ed \} ; ∀ s , t$$

$${δ}^{\{ \cdot \}} {ε}_{st}^{\{ \cdot \}} {x}_{c}^{\{ \cdot \}} {Cap}_{c}^{\{ \cdot \}} \leq {P}_{st}^{\{ \cdot \} , in} \leq {ε}_{st}^{\{ \cdot \}} {x}_{c}^{\{ \cdot \}} {Cap}_{c}^{\{ \cdot \}} , \{ \cdot \} = \{ chp , ed \} ; ∀ s , t$$

$$\{ \begin{matrix}{P}_{st}^{\{ \cdot \} , in} - {P}_{s , t - 1}^{\{ \cdot \} , in} \leq {Ra}_{st}^{\{ \cdot \}} \leq {Ra}_{max}^{\{ \cdot \}} \\ {P}_{s , t - 1}^{\{ \cdot \} , in} - {P}_{st}^{\{ \cdot \} , in} \leq {Ra}_{st}^{\{ \cdot \}} \leq {Ra}_{max}^{\{ \cdot \}}\end{matrix} , \{ \cdot \} = \{ chp , ed \} ; ∀ s , t$$

$${P}_{st}^{\{ \cdot \} , out} = {η}^{\{ \cdot \}} {P}_{st}^{\{ \cdot \} , in} , \{ \cdot \} = \{ chp , ed \} ; ∀ s , t$$

$${Q}_{st}^{chp , out} = {κ}^{chp} ( {P}_{st}^{chp , in} - {P}_{st}^{chp , out} ) ; ∀ s , t$$

where k represents the intra-day time periods, Nₜ represents the number of the intra-day time periods, chp and ed represent the fuel cell and the electrolyzer, respectively, {⋅} represents the set of two devices, Iₛₜ^{{⋅},on} [symbol] Iₛₜ^{{⋅},off} represent the on-state and off-state of these two devices, respectively, Nₘᵢₙ^{{⋅},on} [symbol] Nₘᵢₙ^{{⋅},off} represent the minimum on-state and off-state time of these two devices, and Nₘₐₓ^{{⋅},on} represents the maximum on-state time of these two devices; εₛₜ^{{⋅}} [symbol] ε_{s,t-1}^{{⋅}} represent the state of these two devices within time periods t and t−1, respectively, δ^{{⋅}} represents the minimum operation capacity percentage of these two devices, x_{c}^{{⋅}} represents the 0-1 installation variables of these two devices, and Cap_{c}^{{⋅}} represents the candidate installation capacity of these two devices; Pₛₜ^{chp,in} [symbol] Pₛₜ^{chp,out} [symbol] Qₛₜ^{chp,out} represent the input hydrogen power, output electric power and output thermal power of the fuel cell, respectively, Pₛₜ^{ed,in} [symbol] Pₛₜ^{ed,out} represent the input electric power and output hydrogen power of the electrolyzer, respectively, Raₛₜ^{{⋅}} represents the ramping ratio of these two devices, Raₘₐₓ^{{⋅}} represents the maximum ramping ratio of these two devices, η^{{⋅}} represents the energy conversion efficiencies of these two devices, and κ^{chp} represents the heat recovery ratio of the fuel cell; and
step 2.2, operation constraints of the intra-day hydrogen storage device and the seasonal hydrogen storage device (including the battery storage and the thermal energy storage device) are established as follows:

$$0 \leq {P}_{st}^{\{ \cdot \} , + / -} \leq {x}_{i}^{\{ \cdot \}} {Cap}_{i}^{\{ \cdot \}} {μ}^{\{ \cdot \}} , \{ \cdot \} = \{ bs , hs , shs \} ; ∀ s , t$$

$$0 \leq {Q}_{st}^{ts , + / -} \leq {x}_{c}^{ts} {Cap}_{c}^{ts} {μ}^{ts} ; ∀ s , t$$

$${P}_{st}^{\{ \cdot \} +} \cdot {P}_{st}^{\{ \cdot \} -} = 0 , \{ \cdot \} = \{ bs , hs , shs \} ; ∀ s , t$$

$${Q}_{st}^{ts +} \cdot {Q}_{st}^{ts -} = 0 ; ∀ s , t$$

$${x}_{c}^{\{ \cdot \}} {Cap}_{c}^{\{ \cdot \}} {δ}_{min}^{\{ \cdot \}} \leq {E}_{st}^{\{ \cdot \}} \leq {x}_{c}^{\{ \cdot \}} {Cap}_{c}^{\{ \cdot \}} {δ}_{max}^{\{ \cdot \}} , \{ \cdot \} = \{ bs , hs , shs , ts \} ; ∀ s , t$$

$${E}_{s , {N}_{t}}^{\{ \cdot \}} = {E}_{s , 0}^{\{ \cdot \}} = ( {x}_{c}^{\{ \cdot \}} {Cap}_{c}^{\{ \cdot \}} ) / 2 , \{ \cdot \} = \{ bs , hs , shs , ts \} ; ∀ s , t$$

$${E}_{s , t + 1}^{\{ \cdot \}} = {E}_{st}^{\{ \cdot \}} ( 1 - {η}^{\{ \cdot \}} ) + ( {P}_{st}^{\{ \cdot \} +} {η}^{\{ \cdot \} +} - {P}_{st}^{\{ \cdot \} -} / {η}^{\{ \cdot \} -} ) Δ t , \{ \cdot \} = \{ bs , hs , shs , ts \} ; ∀ s , t$$

$${E}_{s , 0}^{shs} = ( 1 - {η}^{shs} {D}_{s - 1} ) ( {E}_{s - 1 , 0}^{shs} + {D}_{s - 1} ( {E}_{s - 1 , {N}_{t}}^{shs} - {E}_{s - 1 , 0}^{shs} ) ) ; ∀ s ∈ [ 2 , {N}_{s} ]$$

$${ε}_{s}^{shs +} + {ε}_{s}^{shs -} \leq 1 ; ∀ s$$

$$0 \leq {P}_{st}^{shs +} \leq {ε}_{s}^{shs +} M , 0 \leq {P}_{st}^{shs -} \leq {ε}_{s}^{shs -} M ; ∀ s , t$$

where bs, hs, shs and ts represent the battery storage, the intra-day hydrogen storage device, the seasonal hydrogen storage device and the thermal energy storage device, respectively, {⋅} represents the set of these four devices, Nₛ represents the number of typical scenarios, Pₛₜ^{bs+} [symbol] Pₛₜ^{bs-} represent the charging power and discharging power of the battery storage, respectively, and Pₛₜ^{hs+} [symbol] Pₛₜ^{hs-} represent the hydrogen charging power and hydrogen discharging power of the intra-day hydrogen storage device, respectively; Pₛₜ^{shs+} [symbol] Pₛₜ^{shs-} represent the hydrogen charging power and hydrogen discharging power of the seasonal hydrogen storage device, respectively; Qₛₜ^{ts+} [symbol] Qₛₜ^{ts-} represent the heat charging power and heat discharging power of the thermal energy storage device, respectively, x_{c}^{{⋅}} represents the 0-1 installation variables of these four energy storage devices, Cap_{c}^{{⋅}} represents the candidate installation capacity of these four energy storage devices, μ^{{⋅}} represents the power-to-capacity installation ratio of these four energy storage devices, and Eₛₜ^{{⋅}} represents the remaining capacity of these four energy storage devices; δₘᵢₙ^{{⋅}} [symbol] δₘₐₓ^{{⋅}} represent the minimum and maximum operating ratio of these four energy storage devices, respectively, E_{s,0}^{{⋅}} [symbol] E_{s,N}_{ₜ}^{{⋅}} represent the capacity of these four energy storage devices in the initial and final time periods, respectively, η^{{⋅}} represents the self-loss coefficients of these four energy storage devices, η^{{⋅}+} [symbol] η^{{⋅}-} represent the energy charging and discharging loss coefficients of these four energy storage devices, respectively, and Dₛ₋₁ represents the number of days within the typical scenario s−1 in a year; and E_{s-1,0}^{shs} [symbol] E_{s-1,N}_{ₜ}^{shs} represent the remaining capacity of the seasonal hydrogen storage device in the initial and final time periods in the scenario s−1, respectively, εₛ^{shs+} [symbol] εₛ^{shs-} represent the 0-1 state variables of hydrogen charge and hydrogen discharge of the seasonal hydrogen storage device in the typical operation scenario s, respectively, and M represents a larger positive number.

Step 3, the robust electric-thermal-hydrogen multi-energy device planning model considering the source-load uncertainties and the buildings' annual net zero energy constraints is established;
step 3.1, the balance constraints of electric, thermal, cold and hydrogen power are established as follows:

$${P}_{st}^{bs -} - {P}_{st}^{bs +} + {P}_{st}^{chp , out} + {P}_{st}^{grid +} - {P}_{st}^{grid -} - {P}_{st}^{hp} + {\tilde{P}}_{st}^{pv} - {P}_{st}^{ed , in} + {\tilde{P}}_{st}^{wt} = {\tilde{P}}_{st}^{el} - {P}_{st}^{se} ; ∀ s , t$$

$${Q}_{st}^{hp , h} + {Q}_{st}^{chp , out} + {Q}_{st}^{st} - {Q}_{st}^{ts +} + {Q}_{st}^{ts -} - {Q}_{st}^{ac , in} = {\tilde{Q}}_{st}^{hl} - {Q}_{st}^{sh} ; ∀ s , t$$

$${Q}_{st}^{ac , out} + {Q}_{st}^{hp , c} = {\tilde{Q}}_{st}^{cl} - {Q}_{st}^{sc} ; ∀ s , t$$

$${P}_{st}^{ed , out} + {P}_{st}^{shs -} - {P}_{st}^{shs +} + {P}_{st}^{hs -} - {P}_{st}^{hs +} = {P}_{st}^{chp , in} ; ∀ s , t$$

where Pₛₜ^{grid+} [symbol] Pₛₜ^{grid-} represent the the zero energy buildings' electric power buying from and selling to the power grid, respectively, \tilde{P}ₛₜ^{el} [symbol] \tilde{P}ₛₜ^{hl} [symbol] \tilde{P}ₛₜ^{cl} represent the electric, thermal and cold loads of the buildings, respectively, and Pₛₜ^{se} [symbol] Pₛₜ^{sh} [symbol] Pₛₜ^{sc} represent the shedding power of the electric, thermal and cold loads of the zero energy buildings, respectively;
step 3.2, output power upper limit constraints of the electric, thermal and cold loads are established as follows:

$$0 \leq {P}_{st}^{se} \leq {δ}_{max}^{se} {\hat{P}}_{st}^{el} ; ∀ s , t$$

$$0 \leq {Q}_{st}^{sh} \leq {δ}_{max}^{sh} {\hat{Q}}_{st}^{hl} ; ∀ s , t$$

$$0 \leq {Q}_{st}^{sc} \leq {δ}_{max}^{sc} {\hat{Q}}_{st}^{cl} ; ∀ s , t$$

where \hat{P}ₛₜ^{el} [symbol] \hat{P}ₛₜ^{hl} [symbol] \hat{P}ₛₜ^{cl} represent the forecast values of the electric, thermal and cold loads of the zero energy buildings, respectively, and δₘₐₓ^{se} [symbol] δₘₐₓ^{sh} [symbol] δₘₐₓ^{sc} represent the maximum output percentages of the electric, thermal and cold loads of the buildings, respectively;
step 3.3, power grid exchange power constraints and annual zero energy constraints are established as follows:

$$0 \leq {P}_{st}^{grid +} \leq {ε}_{st}^{grid +} {P}_{max}^{grid} , 0 \leq {P}_{st}^{grid -} \leq {ε}_{st}^{grid -} {P}_{max}^{grid} ; ∀ s , t$$

$${ε}_{st}^{grid +} + {ε}_{st}^{grid -} \leq 1 ; ∀ s , t$$

$${\sum }_{s} {\sum }_{t} {P}_{st}^{grid +} Δ t - {\sum }_{s} {\sum }_{t} {P}_{st}^{grid -} Δ t \leq 0$$

where Pₘₐₓ^{grid} represents the upper limit of the exchange electric power with power grid, εₛₜ^{grid+} [symbol] εₛₜ^{grid-} represent the 0-1 state variables of the electric power buying from and selling to the power grid, respectively, and Δt represents the duration of time period t;
step 3.4, the objective function and various specific costs are established as follows:

$${min}_{x} {C}^{inv} + {max}_{u} {min}_{y , z} {C}^{om} + {C}^{grid} + {C}^{deg} + {C}^{ls}$$

$${C}_{ψ}^{inv} = {c}_{ψ}^{inv} {x}_{c}^{ψ} {Cap}_{c}^{ψ} {ϕ}_{ψ}$$

$${C}^{inv} = {C}_{ac}^{inv} + {C}_{bs}^{inv} + {C}_{chp}^{inv} + {C}_{ed}^{inv} + {C}_{hp}^{inv} + {C}_{hs}^{inv} + {C}_{pv}^{inv} + {C}_{shs}^{inv} + {C}_{st}^{inv} + {C}_{ts}^{inv} + {C}_{wt}^{inv}$$

$${ϕ}_{ψ} = {σ ( 1 + σ )}^{{Y}_{ψ}} / ( {( 1 + σ )}^{{Y}_{ψ}} - 1 )$$

$${C}^{om} = {\sum }_{s} {D}_{s} {\sum }_{t} ( \begin{matrix}{c}_{chp}^{on} {I}_{st}^{chp} + {c}_{chp}^{off} {I}_{st}^{chp} + {c}_{ed}^{on} {I}_{st}^{ed} + {c}_{ed}^{off} {I}_{st}^{ed} + {c}_{bs}^{om} ( {P}_{wst}^{bs +} + \\ {P}_{wst}^{bs -} ) + {c}_{chp}^{om} {P}_{wst}^{chp , in} + {c}_{ed}^{om} {P}_{wst}^{ed} + \\ {c}_{hp}^{om} {P}_{st}^{hp} + {c}_{pv}^{om} {P}_{st}^{pv} + {c}_{wt}^{om} {P}_{st}^{wt} + {c}_{hs}^{om} ( {P}_{st}^{hs +} + {P}_{st}^{hs -} ) + \\ {c}_{shs}^{om} ( {P}_{st}^{shs +} + {P}_{st}^{shs -} ) + \\ {c}_{ac}^{om} {Q}_{st}^{ac} + {c}_{st}^{om} {Q}_{st}^{st} + {c}_{ts}^{om} ( {Q}_{st}^{ts +} + {Q}_{st}^{ts -} )\end{matrix} ) Δ t$$

$${C}^{deg} = {\sum }_{s} {D}_{s} {\sum }_{t} ( {c}_{bs}^{deg} ( {P}_{st}^{bs +} + {P}_{st}^{bs -} ) + {c}_{chp}^{deg} {Ra}_{st}^{chp} + {c}_{ed}^{deg} {Ra}_{st}^{ed} ) Δ t$$

$${C}^{grid} = {\sum }_{s} {D}_{s} {\sum }_{t} ( {c}_{st}^{buy} {P}_{st}^{grid +} - {c}_{st}^{sell} {P}_{st}^{grid -} ) Δ t$$

$${C}^{ls} = {\sum }_{s} {D}_{s} {\sum }_{t} ( {c}_{e}^{ls} {P}_{st}^{se} + {c}_{h}^{ls} {Q}_{st}^{sh} + {c}_{c}^{ls} {Q}_{st}^{sc} ) Δ t$$

where Ψ represents the set of devices, Dₛ represents the number of days that the typical scenario s lasts, and C^{inv} [symbol] C^{om} [symbol] C^{grid} [symbol] C^{deg} [symbol] C^{ls} represent the annual investment cost, annual operation and maintenance cost, annual electricity trading cost, annual device degradation cost and annual load shedding cost, respectively; C_{ac}^{inv} [symbol] C_{bs}^{inv} [symbol] C_{chp}^{inv} [symbol] C_{ed}^{inv} [symbol] Cₕₚ^{inv} [symbol] Cₕₛ^{inv} [symbol] Cₚᵥ^{inv} [symbol] Cₛₕₛ^{inv} [symbol] Cₛₜ^{inv} [symbol] Cₜₛ^{inv} [symbol] C_{wt}^{inv} represent the annual investment costs of the absorption chiller, the battery storage, the fuel cell, the electrolyzer, the heat pump, the intra-day hydrogen storage device, the photovoltaic, the seasonal hydrogen storage device, the photothermal plate, the thermal energy storage and the wind turbine, respectively; x represents the 0-1 variables of the robust model at the first stage, u represents uncertain variables at the second stage, y and z represent continuous and 0-1 operation variables in the worst scenario at the second stage, respectively, ϕ_{Ψ} represents the present worth factor, σ represents the discount rate, Y_{Ψ} represents the lifetime of the energy device, and c_{Ψ}^{inv} represents the device unit investment cost; x_{c}^{Ψ} represents 0-1 the device investment variables, Cap_{c}^{Ψ} represents the candidate installation capacity of the energy device, c_{chp}^{on} [symbol] c_{chp}^{off} represent the startup and shutdown cost of the fuel cell, respectively, c_{ed}^{on} [symbol] c_{ed}^{off} represent the startup and shutdown cost of the electrolyzer, respectively, and c_{bs}^{om} [symbol] c_{chp}^{om} [symbol] c_{ed}^{om} [symbol] cₕₚ^{om} [symbol] cₚᵥ^{om} [symbol] c_{wt}^{om} [symbol] cₕₛ^{om} [symbol] cₛₕₛ^{om} [symbol] c_{ac}^{om} [symbol] cₛₜ^{om} [symbol] cₜₛ^{om} represent the unit operation costs of the battery storage, the fuel cell, the electrolyzer, the heat pump, the photovoltaic, the wind turbine, the hydrogen storage, the seasonal hydrogen storage device, the absorption chiller, the photothermal plate and the thermal energy storage device, respectively; c_{bs}^{deg} [symbol] c_{chp}^{deg} [symbol] c_{ed}^{deg} represent the unit degradation costs of the battery storage, the fuel cell and the electrolyzer, respectively, cₛₜ^{buy} [symbol] cₛₜ^{sell} represent the electricity buying and selling costs, respectively, and cₑ^{ls} [symbol] cₕ^{ls} [symbol] c_{c}^{ls} represent the unit load shedding costs of the electric, thermal and cold loads, respectively; and
constraints of intra-day uncertainties such as the electric, thermal and cold loads, output of the wind turbine and solar radiation are established as follows (with the electric load as an example):

$$U = \{ {\tilde{P}}^{el} ∈ {R}^{{N}_{s} \times {N}_{t}} ; {\tilde{P}}_{st}^{el} = {\hat{P}}_{st}^{el} + {P}_{st}^{el +} {Ϛ}_{st}^{el +} - {P}_{st}^{el -} {Ϛ}_{st}^{el -} , \\ {Ϛ}_{st}^{el + / -} ∈ \{ 0 , 1 \} , {\sum }_{t = 1}^{{N}_{t}} ( {Ϛ}_{st}^{el +} + {Ϛ}_{st}^{el -} ) \leq {Γ}_{s}^{el} \} ∀ s , t$$

where U represents the set of the uncertain variables at the second stage, \tilde{P}^{el} represents the uncertain electric load, \tilde{P}ₛₜ^{el} [symbol] \hat{P}ₛₜ^{el} [symbol] Pₛₜ^{el+} [symbol] Pₛₜ^{el-} represent the actual value, the predicted value, the predicted upper deviation value and the predicted lower deviation value of the electric load, respectively, [symbol] [symbol] [symbol] represent the 0-1 variables of the predicted upper deviation value or the predicted lower deviation value of the electric load, respectively, and Γₛ^{el} represents the uncertainty budget parameter of an entire scheduling horizon within a typical operation scenario.

Step 4, the robust electric-thermal-hydrogen multi-energy device planning model is solved by adopting an alternating optimization procedure based column-and-constraint generation algorithm;
step 4.1, electric-thermal-hydrogen multi-energy device planning model is rewritten into a general matrix form:

$${min}_{x} {A}^{T} x + {max}_{u ∈ U} {min}_{y , z ∈ Ω ( x , u )} {C}^{T} y + {D}^{T} z$$

$$s . t . {B}^{T} x \leq b , x ∈ \{ 0 , 1 \}$$

$$Ey + Fz + Gu \leq l - Hx , z ∈ \{ 0 , 1 \}$$

where A [symbol] B [symbol] C [symbol] D [symbol] E [symbol] F [symbol] G [symbol] H [symbol] b [symbol] l represent the set of uncertain variables at the second stage, and Ω(x,u) represents the feasible region of y and z under certain x and u;
step 4.2, the min-max-min two-stage robust planning problem is converted into a main problem and a subproblem, the subproblem is converted into a u-fixed subproblem and a z-fixed subproblem, and the main problem and the subproblem are iteratively solved to obtain the optimization result; where the subproblem is a max-min bilevel optimization problem shown as follows:

$${min}_{x} {A}^{T} x + {max}_{u ∈ U} {min}_{y , z ∈ Ω ( x , u )} {C}^{T} y + {D}^{T} z$$

$$s . t . {B}^{T} x \leq b , x ∈ \{ 0 , 1 \}$$

$$Ey + Fz + Gu \leq l - Hx , z ∈ \{ 0 , 1 \}$$

where x* represents the optimization result in the main problem and serves as known variables to be substituted into the subproblem; and in view of the fact that a max-min problem cannot be directly paired and converted into the max problem to be solved due to the 0-1 variables contained in constraints of the subproblem, and therefore, the subproblem is further decomposed into:
step 4.2.1, the u-fixed subproblem:

$${min}_{y , z} {C}^{T} y + {D}^{T} z$$

$$s . t . Ey + Fz + {Gu}^{*} \leq f - {Hx}^{*} , z ∈ \{ 0 , 1 \}$$

where u* represents the optimization result in the z-fixed subproblem and serves as known variables to be substituted into the u-fixed subproblem; and
step 4.2.2, the z-fixed subproblem:

$${max}_{u , λ} θ = - {λ}^{T} ( l - {Hx}^{*} - Gu - {Fz}^{*} ) + {D}^{T} {z}^{*}$$

$$s . t . - {λ}^{T} E \geq {C}^{T} , {λ}^{T} \geq 0$$

where θ represents the objective function of the z-fixed subproblem, z* represents the optimization result in the u-fixed subproblem and serves as known variables to be substituted into the z-fixed subproblem, λ represents the dual variable of the inequality constraint, and in view of higher difficulty in solution due to the bilinear term λ^{T}u, the above formulation is converted into a linear optimization problem by using the big-M method, and the u-fixed subproblem and the z-fixed subproblem are iteratively solved until convergence to obtain the optimization result of the subproblem;
the m^{th} optimization result u^{m}* of the subproblem is substituted, and new variables yₘ, zₘ are created to obtain the following main problem:

$${min}_{x} {A}^{T} x + η$$

$$s . t . {B}^{T} x \leq b , x ∈ \{ 0 , 1 \}$$

$$η \geq {C}^{T} {y}_{m} + {D}^{T} {z}_{m} , ∀ 1 \leq m \leq r$$

$${Ey}_{m} + {Fz}_{m} + {Gu}^{{m}^{*}} \leq l - Hx , ∀ 1 \leq m \leq r$$

where r represents the total number of iterations, and the main problem and the subproblem are iteratively solved until the convergence condition is met;
step 4.3, the main problem and the subproblem are iteratively solved, and the step that the main problem and the subproblem are iteratively solved includes:
initialization: x⁰ is set as a feasible solution of the main problem, the number of iterations is set as m=1, and x⁰ is substituted into the subproblem iteration processes shown in steps 4.3.2 to 4.3.5 to obtain the subproblem's solution (u^{m}*, θ^{m}*); and the lower boundary LB=−∞ and the upper boundary UB=+∞ are set, and the main problem convergence coefficient ε is set;
step 4.3.1, u^{m}* is substituted into the main problem to obtain the solution (x^{m}*, η^{m}*), and LB=A^{T}x^{m}*+η^{m}* is updated;
step 4.3.2, the number of iterations is set as v=1, z is relaxed as the continuous variable, and x^{m}* is substituted into the z-fixed subproblem to obtain the solution u^{v};
step 4.3.3, (x^{m}*, u^{v}) is substituted into the u-fixed subproblem to obtain the solution (y^{v}, z^{v});
step 4.3.4, (z^{v}, x^{m}) is substituted into the z-fixed subproblem to obtain the solution (u^{v+1}, z^{v+1}), it is set that v=v+1;
step 4.3.5, it is determined whether u^{v}==u^{v-1} is satisfied, if yes, the optimization result (u^{m}*, θ^{m}*)=(u^{v}, θ^{v}) is output, UB=A^{T}x^{m}*+θ^{m}* is updated, and step 4.3.6 is enabled to enter;
or else, step 4.3.3 is returned; and
step 4.3.6, it is determined whether −ε<(UB−LB)/UB<ε is satisfied, if yes, the optimization result is stopped from being output; or else, step 4.3.1 is returned.

In the description of the present description, the description with reference to terms such as “an embodiment”, “example” and “specific example” is intended to indicate that specific features, structures, materials or characteristics described in conjunction with the embodiment or example are included in at least one embodiment or example of the present disclosure. In the present description, the schematic statement for the above-mentioned terms does not necessarily refer to the same embodiment or example. Moreover, the described specific features, structures, materials or characteristics may be combined in an appropriate way in any one or more embodiments or examples.

The basic principles, main characteristics and advantages of the present disclosure are shown and described as above. It should be known by the skilled in the art that the present disclosure is not limited by above-mentioned embodiments, the principle of the present disclosure is only described in the above-mentioned embodiments and the description, various variations and improvements of the present disclosure can be further made without departing from the spirit and scope of the present disclosure. and these variations and improvements shall fall within the scope of the present disclosure.

1. An electric-thermal-hydrogen multi-energy device planning method for zero energy buildings, where the planning method specifically comprises the following steps:
step 1, constructing operation constraints of electric and thermal devices in the zero energy buildings;
step 2, constructing operation constraints of hydrogen devices comprising the electrolyzer, the fuel cell and the hydrogen storage device;
step 3, establishing the robust electric-thermal-hydrogen multi-energy device planning model considering the source-load uncertainties and the buildings' annual net zero energy constraints; and
step 4, solving the robust electric-thermal-hydrogen multi-energy device planning model by adopting an alternating optimization procedure based column-and-constraint generation algorithm;
wherein
the step 1 specifically comprises the following steps:
step 1.1, constructing operation constraints of hydrogen devices comprising the electrolyzer, the fuel cell and the hydrogen storage device; and establishing operation constraints of the absorption chiller, the heat pump and the photothermal plate as follows:
$$0 \leq {Q}_{st}^{ac , in} \leq {x}_{c}^{ac} {Cap}_{c}^{ac} , 0 \leq {P}_{st}^{hp} \leq {x}_{c}^{hp} {Cap}_{c}^{hp} ; ∀ s , t$$
$${Q}_{st}^{ac , out} = {Q}_{st}^{ac , in} {η}^{ac} ; ∀ s , t$$
$$\{ \begin{matrix}{Q}_{st}^{hp , h} = {κ}^{hp} {P}_{st}^{hp} {η}_{h}^{hp} \\ {Q}_{st}^{hp , c} = ( 1 - {κ}^{hp} ) {P}_{st}^{hp} {η}_{c}^{hp}\end{matrix} ; ∀ s , t$$
$${\tilde{Q}}_{st}^{st} = {η}^{st} {x}_{c}^{st} {Cap}_{c}^{st} {\tilde{S}}_{st}^{rad} ; ∀ s , t$$
where subscripts s, t and c represent the typical operation scenario, intra-day time period and candidate device capacity, respectively, superscript ˜ represents the uncertain variables,
Qₛₜ^{ac,in} [symbol] Qₛₜ^{ac,out} represent the input thermal power and output cold power of the absorption chiller, respectively, Pₛₜ^{hp} [symbol] Qₛₜ^{hp,h} [symbol] Qₛₜ^{hp,c} represent the input electric power, output thermal power and output cold power of the heat pump, respectively, Qₛₜ^{st} represents the output thermal power of the photothermal plate, and η^{ac} [symbol] η^{st} represent the conversion efficiency of the absorption chiller and the photothermal plate, respectively;
ηₕ^{hp} [symbol] η_{c}^{p} represent the electric-to-thermal conversion and electric-to-cold conversion efficiency of the heat pump, respectively, κ^{hp} represents the thermal power distribution ratio of the heat pump, x_{c}^{ac} [symbol] x_{c}^{hp} [symbol] x_{c}^{st} represent the 0-1 installation variables of the absorption chiller, the heat pump and the photothermal plate, respectively, Cap_{c}^{ac} [symbol] Cap_{c}^{hp} [symbol] Cap_{c}^{st} represent the candidate installation capacity of the absorption chiller, the heat pump and the photothermal plate, respectively, and \tilde{S}ₛₜ^{rad} represents the solar radiation intensity; and
step 1.2, establishing operation constraints of photovoltaic and wind turbine as follows:
$${\tilde{P}}_{st}^{pv} = {η}^{pv} {x}_{c}^{pv} {Cap}_{c}^{pv} {\tilde{S}}_{st}^{rad} ; ∀ s , t$$
$${\tilde{P}}_{st}^{wt} = {\tilde{ξ}}_{st}^{wt} {x}_{c}^{wt} {Cap}_{c}^{wt} ; ∀ s , t$$
where \tilde{P}ₛₜ^{pv} [symbol] \tilde{P}ₛₜ^{wt} represent the output electric power of the photovoltaic and wind turbine, respectively, x_{c}^{pv} [symbol] x_{c}^{wt} represent the 0-1 installation variables of the photovoltaic and wind turbine, respectively, Cap_{c}^{pv} [symbol] Cap_{c}^{wt} represent the candidate installation capacity of the photovoltaic and wind turbine, respectively, η^{pv} represents the conversion efficiency of the photovoltaic turbine, and \tilde{ξ}ₛₜ^{wt} represents the output ratio of the wind turbine.

2. (canceled)

3. The electric-thermal-hydrogen multi-energy device planning method for the zero energy buildings of claim 1, where the step 2 specifically comprises the following steps:
step 2.1, establishing operation constraints of the fuel cell and the electrolyzer as follows:
$${I}_{st}^{\{ \cdot \} , on} + {I}_{st}^{\{ \cdot \} , off} \leq 1 , \{ \cdot \} = \{ chp , ed \} ; ∀ s , t$$
$${\sum }_{t = k}^{k + {N}_{min}^{\{ \cdot \} , on} - 1} {I}_{st}^{\{ \cdot \} , on} \leq 1 , {\sum }_{t = k}^{k + {N}_{min}^{\{ \cdot \} , on} - 1} ( {I}_{st}^{\{ \cdot \} , on} + {I}_{st}^{\{ \cdot \} , off} ) \leq 1 , \\ \{ \cdot \} = \{ chp , ed \} ; ∀ s , k ∈ [ 1 , {N}_{t} - {N}_{min}^{\{ \cdot \} , on} + 1 ]$$
$${\sum }_{t = k}^{k + {N}_{min}^{\{ \cdot \} , off} - 1} {I}_{st}^{\{ \cdot \} , off} \leq 1 , {\sum }_{t = k}^{k + {N}_{min}^{\{ \cdot \} , off} - 1} ( {I}_{st}^{\{ \cdot \} , on} + {I}_{st}^{\{ \cdot \} , off} ) \leq 1 , \\ \{ \cdot \} = \{ chp , ed \} ; ∀ s , k ∈ [ 1 , {N}_{t} - {N}_{min}^{\{ \cdot \} , off} + 1 ]$$
$${\sum }_{t = k}^{k + {N}_{max}^{\{ \cdot \} , on}} {ε}_{st}^{\{ \cdot \}} \leq {N}_{max}^{\{ \cdot \} , on} , \{ \cdot \} = \{ chp , ed \} ; ∀ s , k ∈ [ 1 , {N}_{t} - {N}_{max}^{\{ \cdot \} , on} ]$$
$${I}_{st}^{\{ \cdot \} , on} - {I}_{st}^{\{ \cdot \} , off} = {ε}_{st}^{\{ \cdot \}} - {ε}_{s , t - 1}^{\{ \cdot \}} , \{ \cdot \} = \{ chp , ed \} ; ∀ s , t$$
$${δ}^{\{ \cdot \}} {ε}_{st}^{\{ \cdot \}} {x}_{c}^{\{ \cdot \}} {Cap}_{c}^{\{ \cdot \}} \leq {P}_{st}^{\{ \cdot \} , in} \leq {ε}_{st}^{\{ \cdot \}} {x}_{c}^{\{ \cdot \}} {Cap}_{c}^{\{ \cdot \}} , \{ \cdot \} = \{ chp , ed \} ; ∀ s , t$$
$$\{ \begin{matrix}{P}_{st}^{\{ \cdot \} , in} - {P}_{s , t - 1}^{\{ \cdot \} , in} \leq {Ra}_{st}^{\{ \cdot \}} \leq {Ra}_{max}^{\{ \cdot \}} \\ {P}_{s , t - 1}^{\{ \cdot \} , in} - {P}_{st}^{\{ \cdot \} , in} \leq {Ra}_{st}^{\{ \cdot \}} \leq {Ra}_{max}^{\{ \cdot \}}\end{matrix} , \{ \cdot \} = \{ chp , ed \} ; ∀ s , t$$
$${P}_{st}^{\{ \cdot \} , out} = {η}^{\{ \cdot \}} {P}_{st}^{\{ \cdot \} , in} , \{ \cdot \} = \{ chp , ed \} ; ∀ s , t$$
$${Q}_{st}^{chp , out} = {κ}^{chp} ( {P}_{st}^{chp , in} - {P}_{st}^{chp , out} ) ; ∀ s , t$$
where k represents the intra-day time periods, Nₜ represents the number of the intra-day time periods, chp and ed represent the fuel cell and the electrolyzer, respectively, {⋅} represents the set of two devices, Iₛₜ^{{⋅},on} [symbol] Iₛₜ^{{⋅},off} represent the on-state and off-state of these two devices, respectively, Nₘᵢₙ^{{⋅},on} [symbol] Nₘᵢₙ^{{⋅},off} represent the minimum on-state and off-state time of these two devices, respectively, and Nₘₐₓ^{{⋅},on} represents the maximum on-state time of these two devices;
εₛₜ^{{⋅}} [symbol] ε_{s,t-1}^{{⋅}} represent the state of these two devices within time periods t and t−1, respectively, δ^{{⋅}} represents the minimum operation capacity percentage of these two devices, x_{c}^{{⋅}} represents the 0-1 installation variables of these two devices, and Cap_{c}^{{⋅}} represents the candidate installation capacity of these two devices;
Pₛₜ^{chp,in} [symbol] Pₛₜ^{chp,out} [symbol] Qₛₜ^{chp,out} represent the input hydrogen power, output electric power and output thermal power of the fuel cell, respectively, Pₛₜ^{ed,in} [symbol] Pₛₜ^{ed,out} represent the input electric power and output hydrogen power of the electrolyzer, respectively, Raₛₜ^{{⋅}} represents the ramping ratio of these two devices, Raₘₐₓ^{{⋅}} represents the maximum ramping ratio of these two devices, η^{{⋅}} represents the energy conversion efficiencies of these two devices, and κ^{chp} represents the heat recovery ratio of the fuel cell; and
step 2.2, establishing operation constraints of the intra-day hydrogen storage device and the seasonal hydrogen storage device as follows:
$$0 \leq {P}_{st}^{\{ \cdot \} , + / -} \leq {x}_{i}^{\{ \cdot \}} {Cap}_{i}^{\{ \cdot \}} {μ}^{\{ \cdot \}} , \{ \cdot \} = \{ bs , hs , shs \} ; ∀ s , t$$
$$0 \leq {Q}_{st}^{ts , + / -} \leq {x}_{c}^{ts} {Cap}_{c}^{ts} {μ}^{ts} ; ∀ s , t$$
$${P}_{st}^{\{ \cdot \} +} \cdot {P}_{st}^{\{ \cdot \} -} = 0 , \{ \cdot \} = \{ bs , hs , shs \} ; ∀ s , t$$
$${Q}_{st}^{ts +} \cdot {Q}_{st}^{ts -} = 0 ; ∀ s , t$$
$${x}_{c}^{\{ \cdot \}} {Cap}_{c}^{\{ \cdot \}} {δ}_{min}^{\{ \cdot \}} \leq {E}_{st}^{\{ \cdot \}} \leq {x}_{c}^{\{ \cdot \}} {Cap}_{c}^{\{ \cdot \}} {δ}_{max}^{\{ \cdot \}} , \{ \cdot \} = \{ bs , hs , shs , ts \} ; ∀ s , t$$
$${E}_{s , {N}_{t}}^{\{ \cdot \}} = {E}_{s , 0}^{\{ \cdot \}} = ( {x}_{c}^{\{ \cdot \}} {Cap}_{c}^{\{ \cdot \}} ) / 2 , \{ \cdot \} = \{ bs , hs , shs , ts \} ; ∀ s , t$$
$${E}_{s , t + 1}^{\{ \cdot \}} = {E}_{st}^{\{ \cdot \}} ( 1 - {η}^{\{ \cdot \}} ) + ( {P}_{st}^{\{ \cdot \} +} {η}^{\{ \cdot \} +} - {P}_{st}^{\{ \cdot \} -} / {η}^{\{ \cdot \} -} ) Δ t , \{ \cdot \} = \{ bs , hs , shs , ts \} ; ∀ s , t$$
$${E}_{s , 0}^{shs} = ( 1 - {η}^{shs} {D}_{s - 1} ) ( {E}_{s - 1 , 0}^{shs} + {D}_{s - 1} ( {E}_{s - 1 , {N}_{t}}^{shs} - {E}_{s - 1 , 0}^{shs} ) ) ; ∀ s ∈ [ 2 , {N}_{s} ]$$
$${ε}_{s}^{shs +} + {ε}_{s}^{shs -} \leq 1 ; ∀ s$$
$$0 \leq {P}_{st}^{shs +} \leq {ε}_{s}^{shs +} M , 0 \leq {P}_{st}^{shs -} \leq {ε}_{s}^{shs -} M ; ∀ s , t$$
where bs, hs, shs and ts represent the battery storage, the intra-day hydrogen storage device, the seasonal hydrogen storage device and the thermal energy storage device, respectively, {⋅} represents the set of these four devices, Nₛ represents the number of typical scenarios, Pₛₜ^{bs+} [symbol] Pₛₜ^{bs-} represent the charging power and discharging power of the battery storage, respectively, and Pₛₜ^{hs+} [symbol] Pₛₜ^{hs-} represent the hydrogen charging power and hydrogen discharging power of the intra-day hydrogen storage device, respectively;
Pₛₜ^{shs+} [symbol] Pₛₜ^{shs-} represent the hydrogen charging power and hydrogen discharging power of the seasonal hydrogen storage device, respectively; Qₛₜ^{ts+} [symbol] Qₛₜ^{ts-} represent the heat charging power and heat discharging power of the thermal energy storage device, respectively, x_{c}^{{⋅}} represents the 0-1 installation variables of these four energy storage devices, Cap_{c}^{{⋅}} represents the candidate installation capacity of these four energy storage devices, μ^{{⋅}} represents the power-to-capacity installation ratio of these four energy storage devices, and Eₛₜ^{{⋅}} represents the remaining capacity of these four energy storage devices;
δₘᵢₙ^{{⋅}} [symbol] δₘₐₓ^{{⋅}} represent the minimum and maximum operating ratio of these four energy storage devices, respectively, E_{s,0}^{{⋅}} [symbol] E_{s,N}_{ₜ}^{{⋅}} represent the capacity of these four energy storage devices in the initial and final time periods, respectively, η^{{⋅}} represents the self-loss coefficients of these four energy storage devices, η^{{⋅}+} [symbol] η^{{⋅}-} represent the energy charging and discharging loss coefficients of these four energy storage devices, respectively, and Dₛ₋₁ represents the number of days within the typical scenario s−1 in a year; and
E_{s-1,0}^{shs} [symbol] E_{s-1,N}_{ₜ}^{shs} represent the remaining capacity of the seasonal hydrogen storage device in the initial and final time periods in the scenario s−1, respectively, εₛ^{shs+} [symbol] εₛ^{shs-} represent the 0-1 state variables of hydrogen charge and hydrogen discharge of the seasonal hydrogen storage device within the typical operation scenario s, respectively, and M represents a larger positive number.

4. The electric-thermal-hydrogen multi-energy device planning method for the zero energy buildings of claim 3, where the step 3 specifically comprises the following steps:
step 3.1, establishing the balance constraints of electric, thermal, cold and hydrogen power as follows:
$${P}_{st}^{bs -} - {P}_{st}^{bs +} + {P}_{st}^{chp , out} + {P}_{st}^{grid +} - {P}_{st}^{grid -} - {P}_{st}^{hp} + {\tilde{P}}_{st}^{pv} - {P}_{st}^{ed , in} + {\tilde{P}}_{st}^{wt} = {\tilde{P}}_{st}^{el} - {P}_{st}^{se} ; ∀ s , t$$
$${Q}_{st}^{hp , h} + {Q}_{st}^{chp , out} + {Q}_{st}^{st} - {Q}_{st}^{ts +} + {Q}_{st}^{ts -} - {Q}_{st}^{ac , in} = {\tilde{Q}}_{st}^{hl} - {Q}_{st}^{sh} ; ∀ s , t$$
$${Q}_{st}^{ac , out} + {Q}_{st}^{hp , c} = {\tilde{Q}}_{st}^{cl} - {Q}_{st}^{sc} ; ∀ s , t$$
$${P}_{st}^{ed , out} + {P}_{st}^{shs -} - {P}_{st}^{shs +} + {P}_{st}^{hs -} - {P}_{st}^{hs +} = {P}_{st}^{chp , in} ; ∀ s , t$$
where Pₛₜ^{grid+} [symbol] Pₛₜ^{grid-} represent the zero energy buildings' electric power buying from and selling to the power grid, respectively, \tilde{P}ₛₜ^{el} [symbol] \tilde{P}ₛₜ^{hl} [symbol] \tilde{P}ₛₜ^{cl} represent the electric, thermal and cold loads of the buildings, respectively, and Pₛₜ^{se} [symbol] Pₛₜ^{sh} [symbol] Pₛₜ^{sc} represent the shedding power of the electric, thermal and cold loads of the zero energy buildings, respectively;
step 3.2, establishing output power upper limit constraints of the electric, thermal and cold loads as follows:
$$0 \leq {P}_{st}^{se} \leq {δ}_{max}^{se} {\hat{P}}_{st}^{el} ; ∀ s , t$$
$$0 \leq {Q}_{st}^{sh} \leq {δ}_{max}^{sh} {\hat{Q}}_{st}^{hl} ; ∀ s , t$$
$$0 \leq {Q}_{st}^{sc} \leq {δ}_{max}^{sc} {\hat{Q}}_{st}^{cl} ; ∀ s , t$$
where \hat{P}ₛₜ^{el} [symbol] \hat{P}ₛₜ^{hl} [symbol] \hat{P}ₛₜ^{cl} represent the forecast values of the electric, thermal and cold loads of the zero energy buildings, respectively, and δₘₐₓ^{se} [symbol] δₘₐₓ^{sh} [symbol] δₘₐₓ^{sc} represent the maximum output percentages of the electric, thermal and cold loads of the buildings, respectively;
step 3.3, establishing power grid exchange power constraints and annual zero energy constraints as follows:
$$0 \leq {P}_{st}^{grid +} \leq {ε}_{st}^{grid +} {P}_{max}^{grid} , 0 \leq {P}_{st}^{grid -} \leq {ε}_{st}^{grid -} {P}_{max}^{grid} ; ∀ s , t$$
$${ε}_{st}^{grid +} + {ε}_{st}^{grid -} \leq 1 ; ∀ s , t$$
$${\sum }_{s} {\sum }_{t} {P}_{st}^{grid +} Δ t - {\sum }_{s} {\sum }_{t} {P}_{st}^{grid -} Δ t \leq 0$$
where Pₘₐₓ^{grid} represents the upper limit of the exchange electric power with the power grid, εₛₜ^{grid+} [symbol] εₛₜ^{grid-} respectively represent the 0-1 state variables of the electric power buying from and selling to the power grid, and Δt represents the duration of time period t;
step 3.4, establishing the objective function and various specific costs as follows:
$${min}_{x} {C}^{inv} + {max}_{u} {min}_{y , z} {C}^{om} + {C}^{grid} + {C}^{deg} + {C}^{ls}$$
$${C}_{ψ}^{inv} = {c}_{ψ}^{inv} {x}_{c}^{ψ} {Cap}_{c}^{ψ} {ϕ}_{ψ}$$
$${C}^{inv} = {C}_{ac}^{inv} + {C}_{bs}^{inv} + {C}_{chp}^{inv} + {C}_{ed}^{inv} + {C}_{hp}^{inv} + {C}_{hs}^{inv} + {C}_{pv}^{inv} + {C}_{shs}^{inv} + {C}_{st}^{inv} + {C}_{ts}^{inv} + {C}_{wt}^{inv}$$
$${ϕ}_{ψ} = {σ ( 1 + σ )}^{{Y}_{ψ}} / ( {( 1 + σ )}^{{Y}_{ψ}} - 1 )$$
$${C}^{om} = {\sum }_{s} {D}_{s} {\sum }_{t} ( \begin{matrix}{c}_{chp}^{on} {I}_{st}^{chp} + {c}_{chp}^{off} {I}_{st}^{chp} + {c}_{ed}^{on} {I}_{st}^{ed} + {c}_{ed}^{off} {I}_{st}^{ed} + \\ {c}_{bs}^{om} ( {P}_{wst}^{bs +} + {P}_{wst}^{bs -} ) + {c}_{chp}^{om} {P}_{wst}^{chp , in} + {c}_{ed}^{om} {P}_{wst}^{ed} + \\ {c}_{hp}^{om} {P}_{st}^{hp} + {c}_{pv}^{om} {P}_{st}^{pv} + {c}_{wt}^{om} {P}_{st}^{wt} + \\ {c}_{hs}^{om} ( {P}_{st}^{hs +} + {P}_{st}^{hs -} ) + {c}_{shs}^{om} ( {P}_{st}^{shs +} + {P}_{st}^{shs -} ) + \\ {c}_{ac}^{om} {Q}_{st}^{ac} + {c}_{st}^{om} {Q}_{st}^{st} + {c}_{ts}^{om} ( {Q}_{st}^{ts +} + {Q}_{st}^{ts -} )\end{matrix} ) Δ t$$
$${C}^{deg} = {\sum }_{s} {D}_{s} {\sum }_{t} ( {c}_{bs}^{deg} ( {P}_{st}^{bs +} + {P}_{st}^{bs -} ) + {c}_{chp}^{deg} {Ra}_{st}^{chp} + {c}_{ed}^{deg} {Ra}_{st}^{ed} ) Δ t$$
$${C}^{grid} = {\sum }_{s} {D}_{s} {\sum }_{t} ( {c}_{st}^{buy} {P}_{st}^{grid +} - {c}_{st}^{sell} {P}_{st}^{grid -} ) Δ t$$
$${C}^{ls} = {\sum }_{s} {D}_{s} {\sum }_{t} ( {c}_{e}^{ls} {P}_{st}^{se} + {c}_{h}^{ls} {Q}_{st}^{sh} + {c}_{c}^{ls} {Q}_{st}^{sc} ) Δ t$$
where Ψ represents the set of devices, Dₛ represents the number of days that the typical scenario s lasts, and C^{inv} [symbol] C^{om} [symbol] C^{grid} [symbol] C^{deg} [symbol] C^{ls} represent the annual investment cost, annual device operation and maintenance cost, annual electricity trading cost, annual device degradation cost and annual load shedding cost, respectively;
C_{ac}^{inv} [symbol] C_{bs}^{inv} [symbol] C_{chp}^{inv} [symbol] C_{ed}^{inv} [symbol] Cₕₚ^{inv} [symbol] Cₕₛ^{inv} [symbol] Cₚᵥ^{inv} [symbol] Cₛₕₛ^{inv} [symbol] Cₛₜ^{inv} [symbol] Cₜₛ^{inv} [symbol] C_{wt}^{inv} represent the annual investment costs of the absorption chiller, the battery storage, the fuel cell, the electrolyzer, the heat pump, the intra-day hydrogen storage device, the photovoltaic, the seasonal hydrogen storage device, the photothermal plate, the thermal energy storage and the wind turbine, respectively;
x represents the 0-1 variables of the robust model at the first stage, u represents uncertain variables at the second stage, y and z represent continuous and 0-1 operation variables in the worst scenario at the second stage, respectively, ϕ_{Ψ} represents the present worth factor, σ represents the discount rate, Y_{Ψ} represents the lifetime of the energy device, and c_{Ψ}^{inv} represents the device unit investment cost;
x_{c}^{Ψ} represents the 0-1 device investment variables, Cap_{c}^{Ψ} represents the candidate installation capacity of the energy device, c_{chp}^{on} [symbol] c_{chp}^{off} represent the startup and shutdown cost of the fuel cell, respectively, c_{ed}^{on} [symbol] c_{ed}^{off} represent the startup and shutdown cost of the electrolyzer, respectively, and c_{bs}^{om} [symbol] c_{chp}^{om} [symbol] c_{ed}^{om} [symbol] cₕₚ^{om} [symbol] cₚᵥ^{om} [symbol] c_{wt}^{om} [symbol] cₕₛ^{om} [symbol] cₛₕₛ^{om} [symbol] c_{ac}^{om} [symbol] cₛₜ^{om} [symbol] cₜₛ^{om} represent unit operation costs of the battery storage, the fuel cell, the electrolyzer, the heat pump, the photovoltaic, the wind turbine, the hydrogen storage the seasonal hydrogen storage device, the absorption chiller, the photothermal plate and the thermal energy storage device, respectively;
c_{bs}^{deg} [symbol] c_{chp}^{deg} [symbol] c_{ed}^{deg} represent the unit degradation costs of the battery storage, the fuel cell and the electrolyzer, respectively, cₛₜ^{buy} [symbol] cₛₜ^{sell} represent the electricity buying and selling costs, respectively, and cₑ^{ls} [symbol] cₕ^{ls} [symbol] c_{c}^{ls} represent the unit load shedding costs of the electric, thermal and cold loads, respectively; and
establishing constraints of intra-day uncertainties such as the electric, thermal and cold loads, output of the wind turbine and solar radiation as follows:
$$U = \{ {\tilde{P}}^{el} ∈ {R}^{{N}_{s} \times {N}_{t}} ; {\tilde{P}}_{st}^{el} = {\hat{P}}_{st}^{el} + {P}_{st}^{el +} {ϛ}_{st}^{el +} - {P}_{st}^{el -} {ϛ}_{st}^{el -} , \\ {ϛ}_{st}^{el + / -} ∈ \{ 0 , 1 \} , {\sum }_{t = 1}^{{N}_{t}} ( {ϛ}_{st}^{el +} + {ϛ}_{st}^{el -} ) \leq {Γ}_{s}^{el} \} ∀ s , t$$
where U represents the set of the uncertain variables at the second stage, \tilde{P}^{el} represents the uncertain electric load, \tilde{P}ₛₜ^{el} [symbol] \hat{P}ₛₜ^{el} [symbol] Pₛₜ^{el+} [symbol] Pₛₜ^{el-} respectively represent the actual value, the predicted value, the predicted upper deviation value and the predicted lower deviation value of the electric load, [symbol] [symbol] [symbol] represent 0-1 variables of the predicted upper deviation value or the predicted lower deviation value of the electric load, respectively, and Γₛ^{el} represents the uncertainty budget parameter of the entire scheduling horizon within a typical operation scenario.

5. The electric-thermal-hydrogen multi-energy device planning method for the zero energy buildings of claim 4, where the step 4 specifically comprises the following steps:
step 4.1, rewriting the electric-thermal-hydrogen multi-energy device planning model into a general matrix form:
$${min}_{x} {A}^{T} x + {max}_{u ∈ U} {min}_{y , z ∈ Ω ( x , u )} {C}^{T} y + {D}^{T} z$$
$$s . t . {B}^{T} x \leq b , x ∈ \{ 0 , 1 \}$$
$$Ey + Fz + Gu \leq l - Hx , z ∈ \{ 0 , 1 \}$$
where A [symbol] B [symbol] C [symbol] D [symbol] E [symbol] F [symbol] G [symbol] H [symbol] b [symbol] l represent the set of uncertain variables at the second stage, and Ω(x,u) represents the feasible region of y and z under certain x and u;
step 4.2, converting the min-max-min two-stage robust planning problem into a main problem and a subproblem, converting the subproblem into an u-fixed subproblem and a z-fixed subproblem, and iteratively solving the main problem and the subproblem to obtain the optimization result;
where the subproblem is a max-min bilevel optimization problem shown as follows:
$${max}_{u ∈ U} {min}_{y , z ∈ Ω ( x , u )} {C}^{T} y + {D}^{T} z$$
$$s . t . {B}^{T} {x}^{*} \leq b$$
$$Ey + Fz + Gu \leq l - {Hx}^{*} , z ∈ \{ 0 , 1 \}$$
where x′ represents the optimization result in the main problem and serves as known variables to be substituted into the subproblem; and
step 4.3, iteratively solving the main problem and the subproblem.

6. The electric-thermal-hydrogen multi-energy device planning method for the zero energy buildings of claim 5, where the subproblem in the step 4.2 is further decomposed into:
step 4.2.1, the u-fixed subproblem:
$${min}_{y , z} {C}^{T} y + {D}^{T} z$$
$$s . t . Ey + Fz + {Gu}^{*} \leq f - {Hx}^{*} , z ∈ \{ 0 , 1 \}$$
where u* represents the optimization result in the z-fixed subproblem and serves as known variables to be substituted into the u-fixed subproblem; and
step 4.2.2, the fixed subproblem z:
$${max}_{u , λ} θ = - {λ}^{T} ( l - {Hx}^{*} - Gu - {Fz}^{*} ) + {D}^{T} {z}^{*}$$
$$s . t . - {λ}^{T} E \geq {C}^{T} , {λ}^{T} \geq 0$$
where θ represents the objective function of the z-fixed subproblem, z* represents the optimization result in the u-fixed subproblem and serves as known variables to be substituted into the z-fixed subproblem, λ represents the dual variable of the inequality constraint, and in view of higher difficulty in solution due to the bilinear term λ^{T}u the above formulation is converted into a linear optimization problem by using the big-M method, and the u-fixed subproblem and the z-fixed subproblem are iteratively solved until convergence to obtain the optimization result of the subproblem;
the m^{th} optimization result u^{m}* of the subproblem is substituted, and new variables yₘ, zₘ are created to obtain the following main problem:
$${min}_{x} {A}^{T} x + η$$
$$s . t . {B}^{T} x \leq b , x ∈ \{ 0 , 1 \}$$
$$η \geq {C}^{T} {y}_{m} + {D}^{T} {z}_{m} , ∀ 1 \leq m \leq r$$
$${Ey}_{m} + {Fz}_{m} + {Gu}^{{m}^{*}} \leq l - Hx , ∀ 1 \leq m \leq r$$
where r represents the total number of iterations, and the main problem and the subproblem are iteratively solved until the convergence condition is met.

7. The electric-thermal-hydrogen multi-energy device planning method for the zero energy buildings of claim 6, where the step of iteratively solving the main problem and the subproblem in the step 4.3 comprises:
initialization: setting x⁰ as a feasible solution of the main problem, setting the number of iterations as m=1, and substituting x⁰ into the subproblem iteration processes shown in steps 4.3.2 to 4.3.5 to obtain the subproblem's solution (u^{m}*, θ^{m}*); and setting the lower boundary LB=−∞ and the upper boundary UB=+∞, and setting the main problem convergence coefficient ε;
step 4.3.1, substituting u^{m}* into the main problem to obtain the solution (x^{m}*, η^{m}*), and updating LB=A^{T}x^{m}*+η^{m}*;
step 4.3.2, setting the number of iterations as v=1, relaxing z as the continuous variable, and substituting x^{m}* into the z-fixed subproblem to obtain the solution u^{v};
step 4.3.3, substituting (x^{m}*, u^{v}) into the u-fixed subproblem to obtain the solution (y^{v}, z^{v});
step 4.3.4, substituting (z^{v}, x^{m}) into the z-fixed subproblem to obtain the solution (u^{v+1}, z^{v+1}), setting v=v+1;
step 4.3.5, determining whether u^{v}==u^{v-1} is satisfied, if yes, outputting the optimization result (u^{m}*, θ^{m}*)=(u^{v}, θ^{v}), updating UB=A^{T}x^{m}*+θ^{m}*, and entering step 4.3.6; or else, returning to step 4.3.3; and
step 4.3.6, determining whether −ε<(UB−LB)/UB<ε is satisfied, if yes, stopping outputting the optimization result; or else, returning to step 4.3.1.

8. The electric-thermal-hydrogen multi-energy device planning method for the zero energy buildings of claim 3, where the seasonal hydrogen storage device comprises the battery storage and a thermal energy storage device.

9. The electric-thermal-hydrogen multi-energy device planning method for the zero energy buildings of claim 4, where the seasonal hydrogen storage device comprises the battery storage and a thermal energy storage device.
